(19) United States
(12) Patent Application Publication
(10) Pub. No.: US 2002/0065688 A1
(43) Pub. Date: May 30, 2002

(54) Electronic reservation system

(76) Inventors: David Charlton, Los Angeles, CA (US); Robert Douglas Jeffroy, London (GB); Philip Guy Howell Morgan, Hounslow (GB); John Mornement, Buckinghamshire (GB)

Correspondence Address: STERNE, KESSLER, GOLDSTEIN & FOX PLLC, 1100 NEW YORK AVENUE, N.W., SUITE 600, WASHINGTON, DC, 20005-3934, US

(21) Appl. No.: 09/939,799

(22) Filed: Aug. 28, 2001

(30) Foreign Application Priority Data
Aug. 29, 2000 (GB) 0021204.3

(51) Int. Cl. G06F 17/60

(52) U.S. Cl. 705/5

(57) ABSTRACT

In a web-based reservation system, the user enters requirements such as routes and date ranges at a terminal (1) and submits them to a web server (2) which retrieves a corresponding data set from a reservation database (6, 7). The user then enters a query that is applied to the retrieved data set to extract a subset thereof for display. The user may apply further queries to the subset, so as to modify the displayed information. In this way, the user may rapidly find and make a suitable reservation without the need repeatedly to send further queries to the server (2). The terminal displays fare availability information for a range of different dates and/or times, by means of indicia indicating availability of one or more fare types at the associated date and/or time. This allows the user quickly to comprehend fare availability across a range of dates or times.

The present invention relates to a reservation system, particularly to a system for making electronic reservations over a network, such as the Internet.

Various electronic reservation systems have been proposed or are currently in use. For example, ‘TheTrainLine.com’ is a web-based train ticket reservation system which allows users to specify a departing station, an arriving station, departure and arrival times and dates and a fare type. The system displays the tickets available which meet these requirements and allows the user to select and book a ticket on-line. Frequently, however, there are no tickets available at a suitable time or price. The user may then return to a previous page, alter their specified requirements and submit a new request to the system. Typically, each request involves a considerable delay while a bookings database is interrogated and the new information is downloaded to the user's browser. Moreover, the form in which the database can be interrogated and the results displayed is inflexible.

U.S. Pat. No. 4,862,357 discloses a dial-up flight reservation system in which a computer is used to access a remote database of schedule, fare and limitation information and retrieve information on flights which meet criteria specified by the user. Flights which meet these criteria are ranked according to the user's travel preferences, stored locally on the computer. Flights for which there is no availability may be excluded.

Web-based fare searching engines such as Travelocity™ and Expedia™ allow users to specify outward and return dates and display a list of fares ranked according to price, or allow the user to search for the cheapest fares without specifying a date. Travelocity™ also displays a calendar showing availability for outbound flights.

According to one aspect of the present invention, there is provided a reservation system in which a terminal is connectable to a server over a network, such as the Internet. User requirement data is entered at the terminal and submitted to the server over the network. The server retrieves a data set from a reservation database in accordance with the submitted user requirement data, and the data set is transmitted to the terminal, preferably in a compressed form. The user then enters a query which is applied to the retrieved data set to extract a subset thereof, which is displayed to the user. The user may apply further queries to the subset, or may modify the original query, so as to modify the displayed information. In this way, the user may rapidly find and make a suitable reservation without the need repeatedly to send further queries over the network.

According to another aspect of the present invention, there is provided a method of displaying availability for two or more types of interrelated reservations, such as an outbound and a return flight. When a reservation of one type is selected, the display is updated to show availability of the other type of reservation on the basis of rules which govern the availability of combinations of the different types.

According to another aspect of the present invention, there is provided a method of encoding availability information in an array, wherein the position of the availability information within the array determines to what reservation item, such as a day or a specific journey, the information relates.

Specific embodiments of the present invention will now be described with reference to the accompanying drawings, in which:

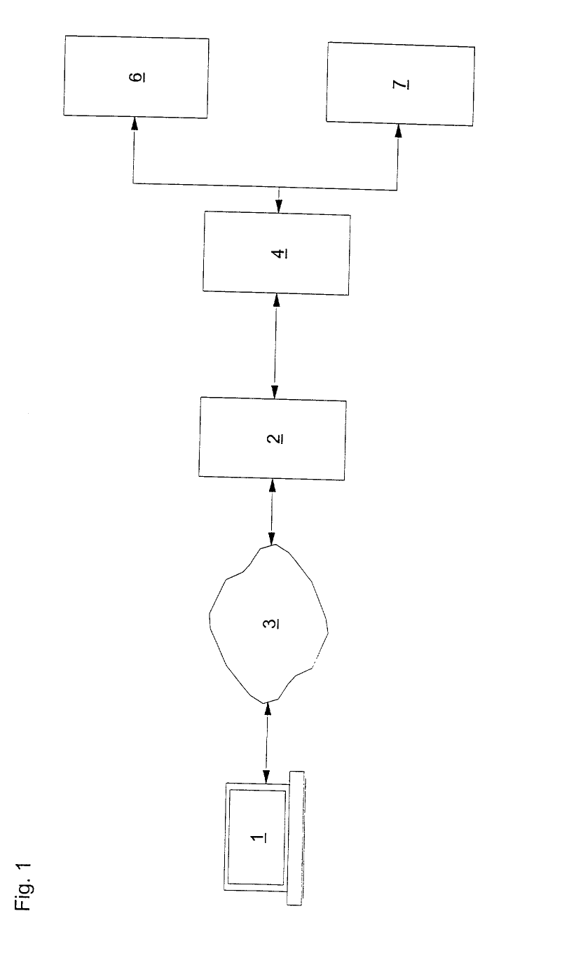

FIG. 1 is a schematic diagram of the main components of a system in an embodiment of the present invention;

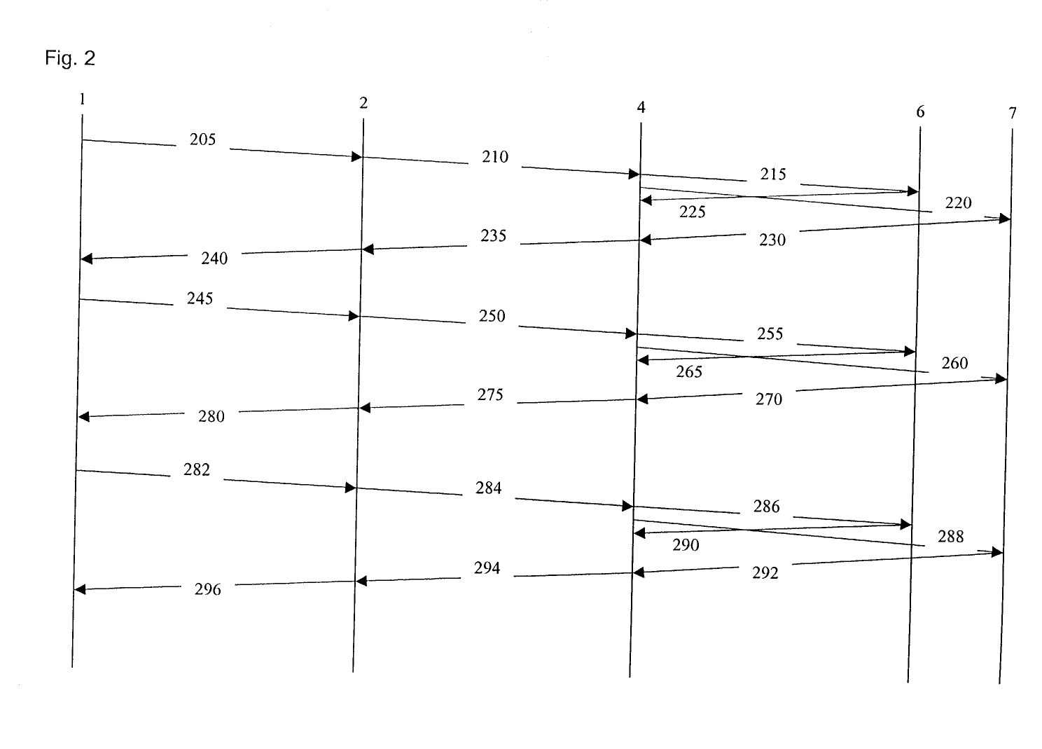

FIG. 2 is a time diagram of signals passed between the main components in the operation of the system;

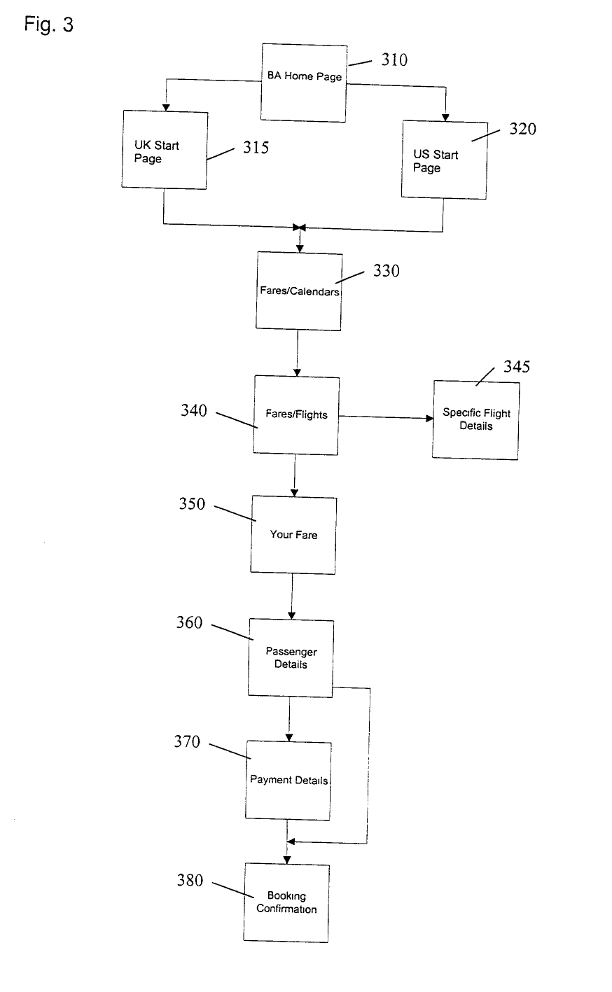

FIG. 3 is a diagram of sequence of screens in operation of the system;

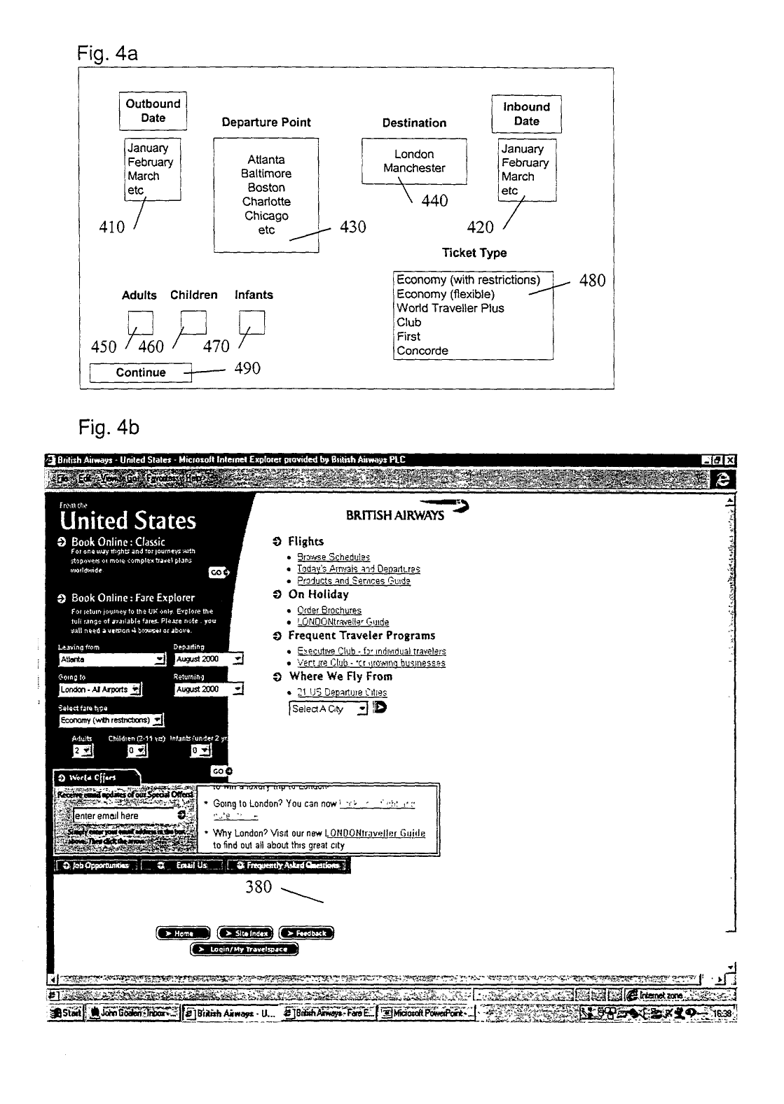

FIGS. 4a and 4b show respectively schematic and sample browser windows for a start page;

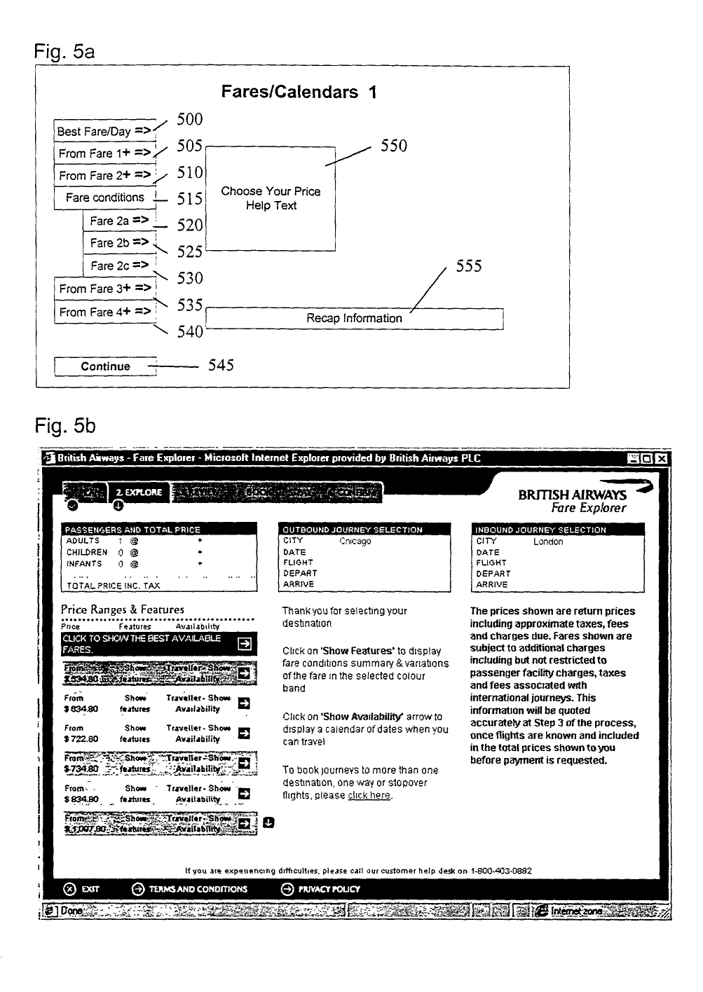

FIGS. 5a and 5b show respectively schematic and sample browser windows for a first Fares/Calendars page;

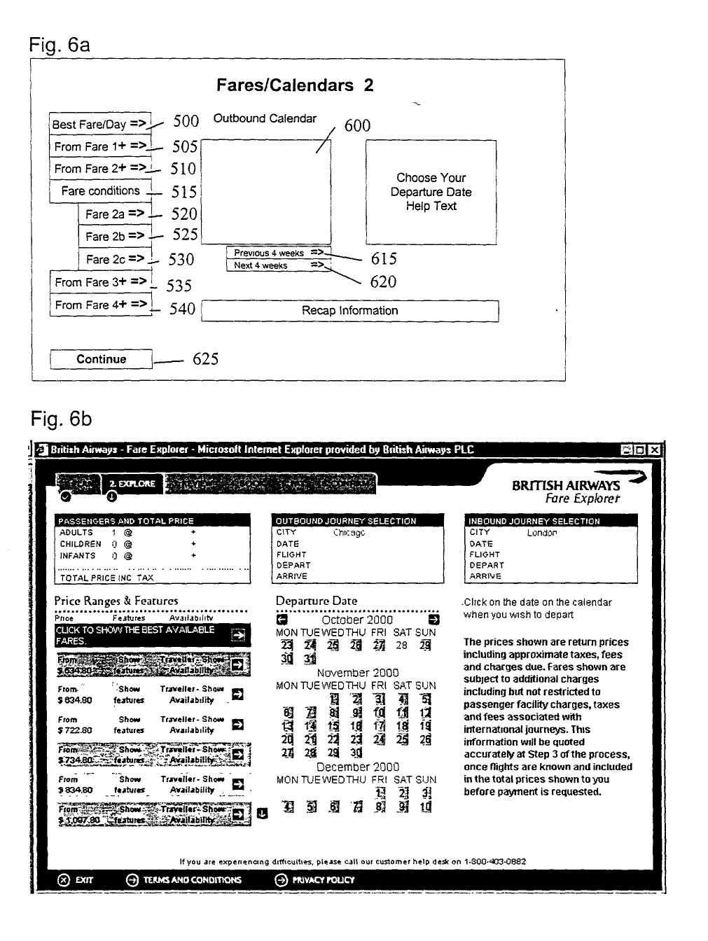

FIGS. 6a and 6b show respectively schematic and sample browser windows for a second Fares/Calendars page;

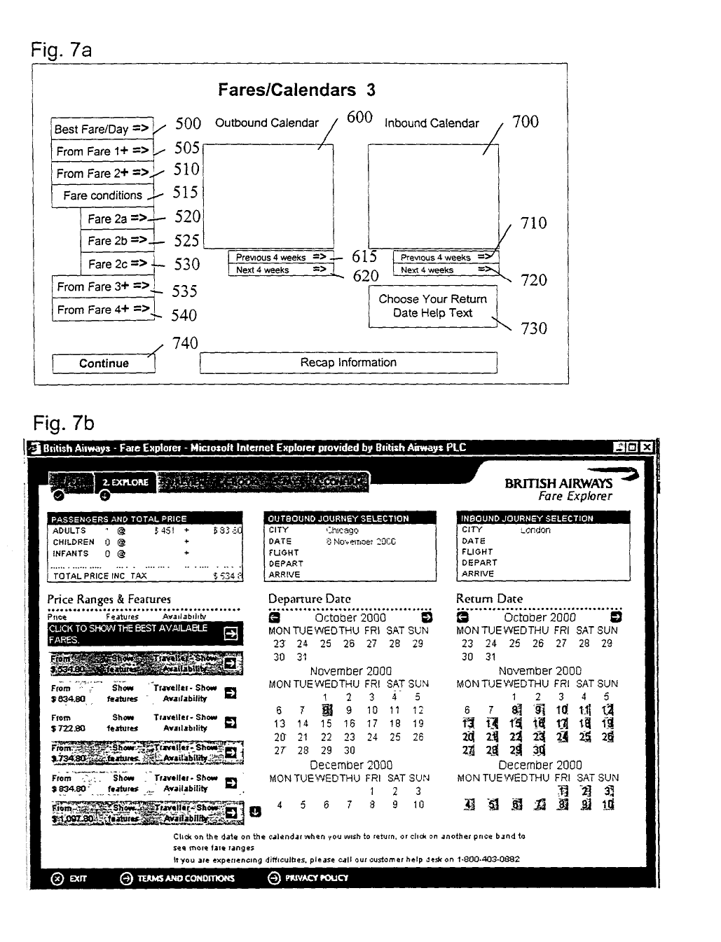

FIGS. 7a and 7b show respectively schematic and sample browser windows for a third Fares/Calendars page;

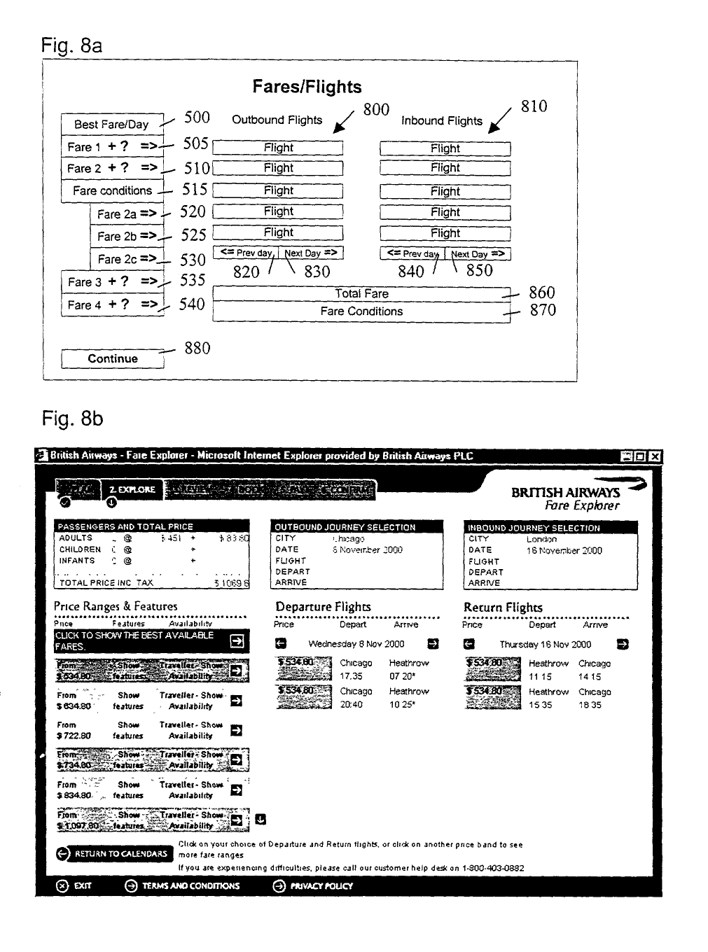

FIGS. 8a and 8b show respectively schematic and sample browser windows for a Fares/Flights page; and

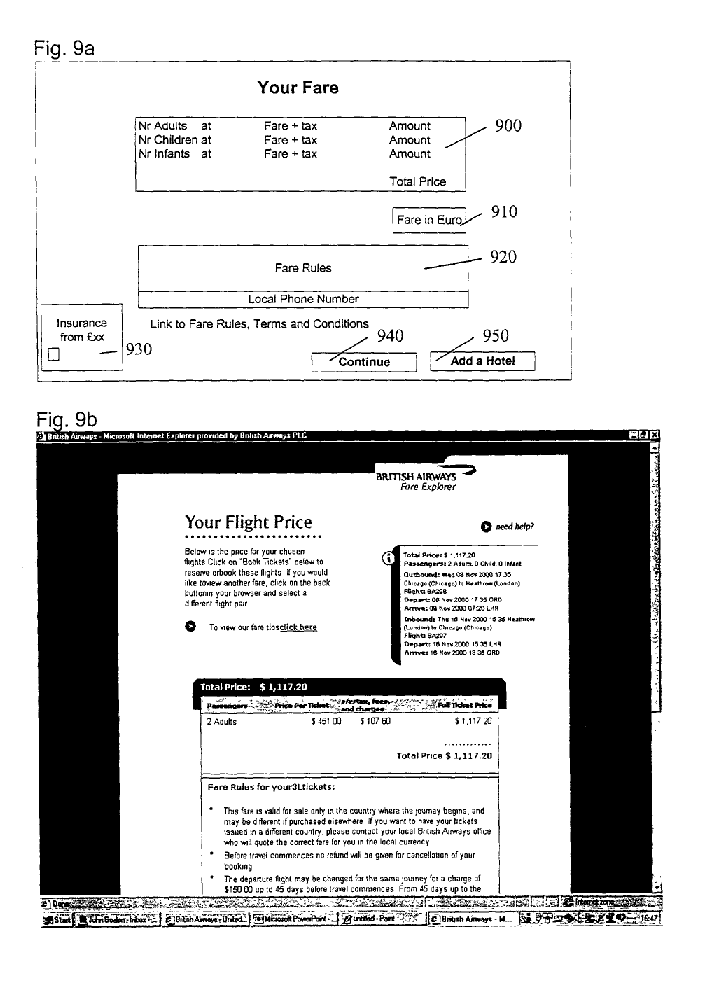

FIGS. 9a and 9b show respectively schematic and sample browser windows for a Fare page.

A specific embodiment of the present invention is a web-based system in which users operate terminals which access a web server over the Internet and run web browser software which provides an interactive display. The protocols by which web-based access is provided, such as http, html and TCP/IP, are well-known in the art and will not be further described except where necessary to explain a specific function of the system.

A system embodying the invention is shown in FIG. 1. The system comprises a terminal 1, such as a PC or Macintosh™, running standard version 4 compliant browser software, such as Microsoft™ Internet Explorer™ version 4 or above, or Netscape™ Navigator™ version 4 or above. The terminal 1 is connected to a web server 2 via the Internet 3, for example via a dial-up PSTN or ISDN connection using PPP to connect to an ISP server (not shown). The web server 2 is in turn connected to a business logic server 4, which is able to query databases stored on mass data storage 5. The databases comprise a flight schedule database 6 and a corresponding fares database 7 together with interface hardware and software, such as the Phoenix databases operated by British Airways plc.

It is common practice in the airline industry that the ticket allocation for a flight be split between different cabin classes, for example first, business and economy. In general, first class tickets will be more expensive than business class tickets, which in turn will be more expensive than economy class tickets. Furthermore within each cabin class the airline may split the ticket allocation into different ticket types having different restrictions associated therewith, for example, minimum or maximum stay conditions, advance purchase conditions, cancellation conditions or return flight conditions. In general, the more restrictions associated with a ticket, the cheaper the fare, with tickets with no restrictions being more expensive.

For historical reasons, availability and price information are usually stored in separate databases. The fares database stores, for each flight, the price of each different type of ticket for the flight. The availability database stores, for each flight operated by the airline, the type of different tickets on the flight, including class and any restrictions, and for each different ticket type the number of tickets currently available for purchase. Before a booking is made, the availability database is queried to determine whether the requested number of tickets of the requested type is available. Once a booking is made, the number of tickets of that type stored in the availability database is decremented by the booked number of tickets. Schedule data indicating the flight number, the flight route, the date of the flight, the departure and arrival times of each flight are contained within the availability database, but may alternatively be stored in a separate database cross-referenced to the fares and availability databases, or merged within the fares database.

The user of the terminal 1 enters requests for information which are sent by the browser software to the web server 2. The business logic server 4 receives requests from the web server 2 and returns the requested flight schedule, availability and fare information from the databases 6 and 7. The web server 2 formats the information together with templates and scripts which are downloaded by the terminal 1 and processed by the browser software to generate displays for the user.

The user may use the browser to process the information so as to display a calendar on which the lowest fare available for each date is indicated or alternatively to display a calendar indicating the dates for which there is available a fare within a selected price range. Advantageously, the system allows multiple queries to be handled at the browser level without each individual query having to be sent for processing at the web server 2. As a further advantage, the browser applies fares rules so that if an inbound or outbound date or flight is selected, the display is updated to show corresponding outbound or inbound dates or flights available according to the applicable fare rule.

A specific reservation transaction will now be illustrated with reference to FIGS. 2 to 9 of the drawings. FIGS. 4a to 9a show schematic browser windows, while FIGS. 4b to 9b show screenshots of the browser windows in operation; these may differ in minor detail from the corresponding schematic browser windows. Copyright may subsist in the design of the browser windows and is not waived by virtue of the inclusion of the screenshots in the present application.

A user of the terminal 1 accesses the web server 2 by running the browser, specifying a URL, such as ‘www.britishairways.com’, and optionally by entering login information and/or following links to a reservation home page 310. From there, the user follows a link either to a UK start page 315 or a US start page 320, depending on whether the user wishes to depart from the UK or the US. The selection of these pages may be done automatically, for example according to the user's login details or the contents of a ‘cookie’ stored on the terminal 1.

The format of both start pages 315, 320 is shown in FIG. 4a, while FIG. 4b is a sample of the US start page 320. The page includes data input fields as defined below in Table 1.

TABLE 1
Input Fields

| | | | Default | |
|---|---|---|---|---|
| Ref. | Field | Type | Value | Valid Input |
| 450 | Nr of adults | drop | 2 | numeric, from 1 to configured |
| | | down | | maximum (5) |
| 460 | Nr of | drop | 0 | numeric, from 0 to one less than |
| | children | down | | configured maximum (4) |
| 470 | Nr of infants | drop | 0 | numeric, from 0 to configured |
| | | down | | maximum (5) |
| 410 | Date of | drop | Current | a month (even though a month is |
| | departure | down | month | selected a predetermined number |
| | | | | of days will end up being |
| | | | | displayed) |
| 420 | Date of | drop | Current | a month (same as or later than the |
| | Return | down | month | departure month but before the end |
| | | | | of the schedule system range) |
| 430 | Departure | drop | Select | city (if on a regional Home Page |
| | Point | down | | the list will be limited to cities |
| | | | | in that county) |
| 440 | Destination | drop | Select | city |
| | | down | | |
| 480 | Ticket Type | drop | Select | One of Economy (with |
| | | down | | restrictions), Economy (flexible), |
| | | | | World Traveller Plus, Club, First |
| | | | | and Concorde. |

The user selects the required options from the drop-down menus. The page may include a script which updates the drop-down menus as options are selected, for example to show only possible destinations in the destination menu for a selected departure point, and vice versa. The user clicks on a ‘Continue’ or ‘Go’ button 490 to submit the selected options. The options are transmitted in a compressed format to the web server 2 (step 205) and are then passed to the business logic server 4 (step 210).

The business logic server 4 accepts the requested options and separates the request into a fares database query (step 215) and an availability database query (step 220).

For each specified departure or return month, the business logic server 4 sets a date range in the query to give a predetermined number of days greater than one moth, such as 49 or 60 days, centred around the specified month. For example:

Selected month April 2000

Number of days=49

[symbol] date range=March 23 to May 10

If the start date of the range is before today's date then the date range is set as the predetermined number of days from today's date.

If the end date of the range is past the schedule system's end date then the date range is set to give the predetermined number of days ending on the schedule system end date.

If the user selected Economy with restrictions as ticket type, the business logic server 4 obtains information for Economy (restricted) and Economy (flexible) ticket types. If other ticket types are selected, the business logic server 4 obtains information for all ticket types apart from Economy (restricted), i.e. Economy (flexible), World Traveller Plus, Club, First and Concorde.

The business logic server 4 obtains fares records from the fares database 6 (step 225) and availability records from the availability database 7 (step 230), for all outward and inbound flights within the respective date ranges for the selected route and the ticket types based on the user-selected ticket type as described above. The business logic server 4 then merges the availability records and the fares records into combined availability-fares records, compresses the combined records and sends the compressed combined records to the web server 2 (step 235).

The compressed combined records indicate, for each date within the outbound and inbound date ranges, whether there is at least one flight with the requested number of tickets available for each of the requested ticket types. Hence, the compressed combined records contain information on availability for each day, but not for specific flights within each day. This information is indicated as an array of flags each indicating whether there is availability for one day, with the position within the array indicating to which day the flag applies. For example, the array may have the values:

(000000011110001101000111100011110001111000111100)

showing days 1 to 7 as unavailable as there is a 7 day advance purchase requirement for that ticket type, days 8 to 11 as including at least one flight having the requested number of tickets available at the requested ticket type, days 12 to 14 unavailable as the particular ticket type is not available from Friday to Sunday, days 15 and 16 as having at least one flight with the requested availability, day 17 as unavailable because all of the requested ticket type are sold out or there are no flights with the requested number of tickets available, and so on up to day 49. There is one outbound array and one inbound array for each requested ticket type. The array may be represented as a text string or binary.

The compressed combined records also include two further arrays for each requested ticket type which allow the browser to take into account minimum and maximum stay rules. The Earliest Return Date array indicates the earliest date on which the customer can return if a specific outbound date has been chosen, with the position within the array indicating the specific outbound date. For example, the array may have the values: (7, 8, 9, 10, 11, 12, 13, 14 . . . )

so that, for example, if a customer chooses day 8 as the outbound date then the earliest return date, indicated at position 8, is day 14. The Latest Return Date array is similar, but indicates the latest date on which the customer may return, so as to take into account maximum stay rules.

Hence, the compressed combined records allow automatic application of fare rules by the browser.

The web server 2 sends (step 240) the compressed combined records to the terminal 1 together with executable code, such as Java™ scripts, and formatting information which allow the browser to display selections of information from the combined records according to selections made by the user, in a series of Fares/Calendars windows which will now be described.

The browser next displays a first Fares/Calendars screen 330, shown schematically in FIG. 5a; a sample display is shown in Figure 5b. The first Fares/Calendars screen includes the display fields described below in Table 2.

TABLE 2
First Fares/Calendars Display Fields

| Ref. | Display | Notes |
|---|---|---|
| 505, 510, | From Fare | The lowest adult fare for a fare type |
| 535, 540 | | Example: From £260 |
| 515 | Fare Conditions | The conditions associated with the fare |
| | | type. |
| | | (Advance purchase, minimum stay, |
| | | maximum stay, cancellation permission |
| | | and charges, rebook permission and |
| | | charges, valid airports) |
| | | Example: Buy at least 7 days before |
| | | departure. |
| | | Must stay over Saturday night. |
| | | Must return within 1 month. |
| | | Cancel: Permitted anytime at a |
| | | charge of 30% |
| | | Rebook: Not permitted |
| 520, 525, | Sub Fare | Exact adult fare for the ‘from Fare’ |
| 530 | | fare type based on days of the |
| | | week and seasonality |
| | | Example. Leave Mon, Tue, Wed, Thu |
| | | Return Mon, Tue, Wed, Thu |
| | | from 04 Feb until 31Mar |
| 550 | Choose Your | Text to help the customer to navigate |
| | Price Help Text | through the screens |
| 555 | Recap Bar | Recap information on the options |
| | | selected so far |

Separate display fields are provided for a plurality of ticket types, based on the ticket type chosen, as shown in Table 3 below:

TABLE 3
Ticket Types

| Ticket Type Chosen | Fares Displayed |
|---|---|
| Economy (with restrictions) | Economy (restricted), Flexible Economy |
| Flexible | Flexible Economy, World Traveller Plus, |
| | Club |
| World Traveller Plus | World Traveller Plus, Club, First |
| Club | Club, First, Concorde |
| First | First, Concorde |
| Concorde | Concorde |

Hence, in the example shown in FIG. 5a, if ‘Economy Flexible’ is the selected ticket type, ‘From fare 1’ display field 505 displays the cheapest Flexible Economy fare for the route and date ranges selected, ‘From fare 2’ display field 510 displays the cheapest World Traveller Plus fare, ‘From fare 3’ display field 535 displays the cheapest Club fare and ‘From fare 4’ display field 540 is not used.

If the requested ticket type is not available or doesn't exist on the selected route, then the next lower fare ticket type is selected for display instead.

Each fare display field 500-540 is displayed with a background colour corresponding to the ticket type to which it relates. Each fare display field includes at least two buttons, indicated by ‘+’ and ‘=>’ in FIG. 5a and ‘Show features’ and ‘Show Availability’ in FIG. 5b. Clicking on either of these buttons causes a script to be executed locally by the browser to display information as described below, derived from the combined fares and availability information already received from the web server 2.

The ‘+/show features’ button, when clicked by the user, causes the fare conditions field 515 and sub fare fields 520, 525, 530 to be displayed for the selected ticket type, as shown for ticket type ‘2’ in FIG. 5a. The ‘+/show features button’ may be replaced by a ‘−/hide features’ button, which when clicked causes the fare conditions field 515 and sub fare fields 520, 525, 530 to be hidden, as shown in FIG. 5b. The sub fare fields each indicate a specific fare available within the corresponding ticket type. The specific fares differ from each other according to seasonality and whether a flight departs and returns midweek, departs and returns on weekends or departs midweek or at the weekend and returns on the other.

Clicking the ‘=>/Show availability’ button causes the browser to display a second Fares/Calendars window 330, as shown in FIGS. 6a and 6b, including an outbound calendar 600 of the outbound date range, with those dates highlighted for which the selected ticket type is available, preferably with a background colour corresponding to that ticket type.

Each sub fare field 520, 525, 530 includes a ‘=>/show availability’ button which, when clicked, causes the browser to display the second Fares/Calendars window 330, including an outbound calendar 600 of the outbound date range, with those dates for which the corresponding fare is available highlighted, preferably with a background colour corresponding to the ticket type within which the fare falls.

If the ‘Best Fare’ field 500 is clicked, the browser displays the second Fares/Calendars window 330, including an outbound calendar 600 for the outbound date range, with each day highlighted with a background colour indicating the ticket type of the cheapest available fare departing on that day.

If the user causes a pointer to hover over a particular calendar date in the outbound calendar 600, the actual price of the fare of the ticket type corresponding to the background colour of that date is displayed. Dates for which there are no tickets available of the displayed ticket type or types are shown with a white background and the message ‘no seats’ is displayed if the pointer hovers over any of them. Dates for which there are no flights for the selected route are also displayed with a white background and the message ‘No Seats’ is displayed if the pointer hovers over any of them.

In the Second Fares/Calendars window 330, clicking a ‘Previous 4 weeks’ button 615 causes the outbound calendar 600 to display the requested fare availability information for the previous four weeks, unless today's date appears in the current date range. Clicking a ‘Next 4 weeks’ button 620 causes the outbound calendar 600 to display the requested fare availability information for the previous four weeks. In either case, the combined records for the next or previous four weeks are not available locally and a request for these records is sent to the web server 2 and thence to the business logic server 4 for interrogation of the fares and availability databases 6, 7 and the return of a new set of combined records as in steps 205 to 240 shown in FIG. 2.

From the Second Fares/Calendars window 330, the user can select a particular departure date and fare by clicking on that date in the calendar, which is highlighted with a colour corresponding to the ticket type of the selected fare. Once the date is selected, a ‘Continue’ button 625 is displayed. Clicking this button causes a script to be executed locally so as to search the locally stored combined fares and availability records for all days within the return date range for which the requested number of tickets is available at the selected fare and which meet any conditions associated with the selected fare. For example, if the fare has a minimum stay term condition associated with it, then only return days which meet the minimum stay condition and for which there is availability of the requested number of tickets are selected.

The browser then displays the Third Fares/Calendars window 330, as shown in FIGS. 7a and 7b. The outbound calendar 600 is updated so as to highlight only the departure date set by the user. An inbound calendar 700 is displayed, on which the return dates on which the selected fare is available are highlighted with the colour corresponding to that fare. Thus, the user can see at a glance what return dates are available for the selected combination of fare and departure date.

If the pointer hovers over the selected outbound date, the price of the fare is displayed; if over any other date in the outbound calendar, the message ‘Not Chosen’ is displayed. If the pointer hovers over any of the highlighted dates in the inbound calendar, the price of the fare is displayed. If the pointer hovers over a date in the inbound calendar which is not highlighted, the message ‘No Seats’ or ‘No Flights’ will be displayed, according to whether there are flights but insufficient availability, or no flights on that day.

The user can then make a new search of the locally stored records for the availability of a particular fare or sub-fare, by clicking on one of the ‘=>/show availability’ buttons in respectively the fare fields 505, 510, 535, 540 or sub-fare fields 520, 525, 530. If a particular fare or sub-fare is selected then a script is run to search the locally stored records to determine the departure and return dates within which the selected fare or sub-fare is available for the requested number of tickets for at least one flight. The display of the outbound calendar 600 and inbound calendar 700 is then updated to highlight, in the corresponding fare colour, the dates selected by that search.

Alternatively, the user may click the ‘Best Fare/Day’ button 500, in which case a script is executed to find the lowest fare with availability for the requested number of tickets, for each day in the inbound and outbound date ranges. The Third Fares/Calendars window 330 is then updated to highlight each date with the fare colour code of the lowest fare found for that day, as shown in FIG. 7b. If the pointer hovers over a highlighted date, the price of the lowest fare found is displayed; if over a non-highlighted date, the message ‘No Seats’ or ‘No Flights’ is displayed as appropriate.

If a fare, sub-fare or best fare has been selected, the user may then select any highlighted departure or return date by clicking on it. A script is then executed locally to select combinations of the selected departure or return date and respective return or departure dates which meet any terms and conditions applicable to the selected fare. The Third Fares/Calendars window 330 is then updated to highlight with the corresponding fare colour code in the outbound calendar 600 and inbound calendar 700 only the dates of selected combinations. Thus, only the selected departure or return date is highlighted in the appropriate inbound or outbound calendar, while in the other calendar those dates having the requested availability at the selected fare will be highlighted with the appropriate fare code. If the pointer hovers over a highlighted date, the price of the fare on that date is displayed; if on a date not selected in the appropriate calendar, the message ‘not chosen’ is displayed; if on a date not highlighted in the other calendar, the message ‘No Flights’ or ‘No Seats’ is displayed as appropriate.

In the Third Fares/Calendars window 330, clicking the outbound ‘Previous 4 weeks’ button 615 causes the outbound calendar 600 to display the requested fare availability information for the previous four weeks, unless today's date appears in the current date range, and clicking the outbound ‘Next 4 weeks’ button 620 causes the outbound calendar 600 to display the requested fare availability information for the previous four weeks. The Fares/Calendars window 350 also includes an inbound ‘Previous 4 weeks’ button 710 and an inbound ‘Next 4 Weeks’ button 720, which, when clicked, initiate a request for a set of combined fares/availability records with an inbound date range respectively decremented or incremented by four weeks. The request is sent to the web server 2 and thence to the business logic server 4 for interrogation of the fares and availability databases 6, 7 and the return of a new set of combined records as in steps 205 to 240 shown in FIG. 2. A search is then performed locally on the new set of combined records using the current display selection criteria and the inbound or outbound calendar 700, 600 updated as appropriate.

Once the user has selected an outbound or inbound date and the corresponding available inbound or outbound dates have been displayed, the user then clicks on one of these corresponding available inbound or outbound dates and the respective calendar display is updated so as to highlight only the selected outbound and inbound dates. To confirm this selection, the user then clicks a ‘Continue’ button 740 to proceed to the Fares/Flights window 340. Otherwise, the user may click one of the ‘=>/show availability’ buttons in respectively the fare fields 505, 510, 535, 540 or sub-fare fields 520, 525, 530 to select another fare or the ‘Best Fare’ button to go to the lowest fare display.

As shown in FIGS. 8a and 8b, the Fares/Flights window 340 consists of one or more outbound flight display fields 800 and one or more inbound flight display fields 810, which display details of flights respectively departing on or arriving on the user-selected days. The details are obtained by sending a request to the web server 2 and thence to the business logic server 4, which interrogates the fares and availability databases 6 and 7 and returns the flight details, as shown in steps 245 to 280 of FIG. 2.

The details have a format shown below in Table 4:

TABLE 4
Flight Display Field Format

| Display | Format | Notes | Example |
|---|---|---|---|
| Departure Point | full city name | | London |
| Arrival Point | full city name | | New York |
| Departure Date | ddmmm | | 25MAY |
| Departure and | hh:mm Leave | append*if next | 20:45 Leave |
| arrival times | hh:mm Arrive | day arrival; | 06:00* Arrive |
| | | append** | |
| | | if arrival is 2 days | |
| | | later | |
| Departure and | 3-letter codes, | | LHR |
| destination | next to related | | JFK |
| airport codes | time | | |
| Flight number | BAnnn, | each flight | BA123-Flight |
| | displayed as a | number has an | number can be up |
| | link | associated link | to 4 digits. |
| | | to flight details | |
| Operating Carrier | full text | The operator of | British Airways |
| | | the flight (may be | |
| | | different from | |
| | | the marketing | |
| | | carrier) | |
| Price | Currency | $534.80 | |

Flights with availability of less than the specified number of tickets include the displayed message ‘Sold Out’ while those with up to 8 tickets left at the selected fare include the displayed message ‘Last Few’.

A script displays the flight information according to the following rules. Flights only for the selected days are displayed except in the following cases. If the number of flights to display is less than a predetermined minimum (e.g. 5) then the script searches backwards up to a predetermined number of days (e.g. 7) for the first earlier date with available flights at the selected fare and forward up to the predetermined number of days for the first later date with available flights at the selected fare, and displays flights for the first earlier date, the selected date and the first later date. If no available flights are available on the selected date, then flights are displayed for the first earlier date and first later date.

The flights are always displayed in relation to the last fare selected. Hence, those flights for which the selected fare is available are highlighted with the corresponding fare colour. Flights for which the requested number of tickets at the selected fare is not available are not highlighted, but may instead be greyed out (shown in faint grey text). If the ‘Best Fare’ option was previously selected, each flight display field is highlighted with the colour corresponding to the lowest available fare for that flight. The selected fare type may be changed within the Fares/Flights window 340 by clicking the ‘Best Fare/Day’ button 500, or the ‘=>/Show Availability’ button within one of the fare fields 505, 510, 535, 540 or sub-fare fields 520, 525, 530.

The Fares/Flights window 340 also includes an outbound previous day button 820 and an inbound previous day button 840 which are displayed provided the selected day is not today, and an outbound next day button 830 and an inbound next day button 850, which are displayed provided the selected day is not the last day in the current schedule range. Clicking on the appropriate button changes the outbound or inbound flights display 800 or 810 to show flights on the next or previous day, highlighted according to the selected fare type. If the selection of next or previous day would result in the inbound date being earlier than the outbound date, both the inbound and outbound dates change together.

The user selects individual flights by clicking on the relevant display field 800, 810. Clicking on an outbound display field 800 when no inbound flight has been selected causes the inbound display fields 810 to be refreshed by highlighting only those flights for which tickets are available at the selected fare, or by highlighting with the colour of the lowest available fare if the selected fare type is ‘Best Fare’. The user may then select one of the highlighted inbound flights by clicking on its display field 810.

Likewise, clicking on an inbound display field 810 when no outbound flight has been selected causes the outbound display fields 800 to be refreshed by highlighting only those flights for which tickets are available at the selected fare, or by highlighting the flights with the colour of the lowest available fare if the selected fare type is ‘Best Fare’. The user may then select one of the highlighted outbound flights by clicking on its display field 800.

Once an inbound and outbound flight have been selected, the user may click on the continue button 880. In that case, the browser sends to the web server 2 the following information at step 282, which is then passed to the business logic server 4 at step 284:

Number of adults

Number of children

Number of infants

Identity of outbound flight

Identity of inbound flight

Outbound flight details

Inbound flight details

Currencies for quote (maximum 2)

The business logic server 4 then obtains current fare information for the requested flights from the fares database 6 (steps 286 and 290) and current availability information from the availability database 7 (steps 288 and 292) and passes this information to the web server 2 (step 294), which forwards the information to the terminal 1 (step 296) in a format compatible with the browser. If the requested tickets are no longer available since the information was last obtained at step 270, the browser displays a message that the requested fares are no longer available, requests an updated set of compressed combined records for the current date ranges and returns to the first Fares/Calendars window 330.

The browser then displays a Your Fare window 350 as shown in FIGS. 9a and 9b, including a fare display field 900 in which the fares are itemised for the requested number of adults, children and infants and the total is displayed at the bottom. An equivalent total fare in a second currency is displayed in an alternative currency display field 910. The fare rules applicable to the requested tickets are submitted by the web server 2 and are displayed in a fare rules display field 920. There are different sets of fare rules according to the fare types of the tickets. As optional features, the web server also submits an insurance price for display by the browser in an insurance display field 930, and the browser displays a hotel-booking button 950, which activates a hotel-booking window.

To proceed with the booking, the user clicks on a continue button 940. From this point, the booking proceeds essentially in the same manner as a conventional online booking, through a Passenger Details window 360 in which the user enters details of the passengers, a Payment Details window 370 in which the user enters payment details in order to pay for the transaction, and a Booking Confirmation window 380 in which, if the payment details are accepted, a message confirming the booking is displayed.

Various alternatives or additions to above embodiment may be envisaged, without departing from the scope of the invention as defined by the claims. In one alternative, the terminal 1 is a wireless terminal, using communications protocols such as GPRS, HSCSD or UMTS for communication over a wireless network which may provide a connection to the Internet, or be directly connected to a server otherwise functionally equivalent to the web server 2. Application protocols such as WAP may be used. Alternatively, the terminal 1 may be an interactive TV set.

The terminal 1 may be connected to a travel agent's extranet or an airline's in-house telesales network, to facilitate booking on behalf of customers.

The system described above may be modified to allow the booking of one-way flights, for example by allowing the user to proceed directly from the second Fares/Flights window 340 to the Your Fare window 350 once the user has selected an outbound date. The system may also allow booking of journeys of more than two legs or ‘open jaw’ flights, and allow connecting flights and stopovers.

As an additional feature, the user may specify an outbound and an inbound date and move directly from the start page 315; 320 to the Fares/Flights page 340.

Additional features may be added to allow the compressed combined records to be obtained according to different criteria specified by the user. For example, instead of specifying a fixed departure point and destination, the user may select an option to specify only the departure point and a maximum fare, and the business logic server creates the compressed combined records showing availability at or below the maximum fare for a range of different destinations over specified outbound and inbound date ranges.

The system described above may be applied to the reservation of other types of travel, such as train travel, and to the reservation of other types of service such as hotels, in which case the outbound and inbound dates would be replaced by arrival and departure dates. Instead of fare types, different classes of room may be offered and different rates may be applied according to the length of stay and days of the week, for example.

The system may also be applied to the combined reservation of different types of service, such as flight and hotel packages. For example, the browser may retrieve fares rules and availability for the flights and rates rules and availability for hotels at the destination. This would allow the user to select departure and return dates which give the lowest total cost of the package.

The browser may additionally retrieve from the web server 2 information on events at the departure and destination points within the date ranges. For example, information on school holidays and local festivals may be displayed on the Fares/Calendars screens 330 so as to assist customers in planning their holidays. Various other modifications of the specific embodiments may be envisaged, within the scope of the following claims.

We claim:

1. A method of processing reservation data at a terminal, comprising:
receiving as input at the terminal a request for reservation information including one or more reservation criteria;
transmitting said request over the network to a remote server;
receiving from the remote server a set of reservation data selected according to said one or more reservation criteria;
receiving as input at the terminal a selection request;
selecting for display a subset of reservation data from said set of reservation data in accordance with the selection request; and
displaying said subset of reservation data at the terminal.

2. A method as claimed in claim 1, wherein said one or more reservation criteria specifies a date range and the set of reservation data relates to said date range.

3. A method as claimed in claim 2, wherein said one or more reservation criteria includes a first date range and a second date range and the set of reservation data relates to said first and second date ranges.

4. A method as claimed in claim 3, wherein the selection request indicates a date within the first date range and the selecting step includes selecting, as said subset of reservation data, reservation data relating to a plurality of dates within the second date range, dependent on the indicated date within the first date range.

5. A method as claimed in claim 4, including further receiving as input at the terminal a further selection request indicating one of said plurality of dates within the second date range.

6. A method as claimed in claim 5, including submitting to the remote server a reservation request specifying the dates indicated by said selection requests.

7. A method as claimed in claim 1, wherein said one or more reservation criteria includes a plurality of reservation types and the set of reservation data relates to each of said plurality of reservation types.

8. A method as claimed in claim 7, wherein said selection request indicates a subset of said plurality of reservation types and said subset of reservation data relates to said subset of reservation types.

9. A method as claimed in claim 8, wherein the set of reservation data includes price information relating to each reservation and said selection request causes selection of said subset of reservation data according to said price information.

10. A method as claimed in claim 8, wherein said one or more reservation criteria specifies a date range and the set of reservation data relates to said date range and said subset of reservation data is selected to comprise the lowest price reservation for each day within the date range.

11. A method as claimed in claim 8, wherein said one or more reservation criteria includes a first date range and a second date range and the set of reservation data relates to said first and second date ranges and said subset of reservation data is selected to comprise the lowest price reservation for each day within the date range.

12. A method as claimed in claim 8, wherein the selection request indicates a date within the first date range and the selecting step includes selecting, as said subset of reservation data, reservation data relating to a plurality of dates within the second date range, dependent on the indicated date within the first date range and said plurality of dates are selected according to a selection rule dependent on said subset of reservation types.

13. A method as claimed in claim 1, further including:
receiving as input at the terminal a further request for reservation information including one or more further reservation criteria;
transmitting said further request over the network to a remote server;
receiving from the remote server a further set of reservation data dependent on said one or more further reservation criteria;
selecting for display a further subset of reservation data from said set of further reservation data in accordance with said selection request; and
displaying said further subset of reservation data at the terminal.

14. A method as claimed in claim 12, wherein said one or more reservation criteria specifies a date range and the set of reservation data relates to said date range and said further reservation criteria includes a further date range and the further set of reservation data relates to said further date range.

15. A method of displaying electronically reservation availability information for first and second ranges of reservable items, comprising:
storing reservation availability records for said ranges;
storing reservation rules relating to combinations of one or more reservable items from said first range and one or more reservable items from said second range;
receiving as input a selection of one or more of said items from one of the first and second ranges;
determining amended availability information for the items in the other one of the first and second ranges on the basis of said selection and said reservation rules; and displaying said amended availability information.

16. A method as claimed in claim 15, further including displaying availability information derived from said reservation availability records for said first and second ranges, prior to receiving said selection as input.

17. A method as claimed in claim 15, wherein said reservation availability records are stored locally.

18. A method as claimed in claim 16, wherein said reservation availability records are stored locally.

19. A method as claimed in claim 16, wherein said reservation availability records include an array of availability data, the position within the array indicating the position within the respective range.

20. A method as claimed in claim 15, wherein said reservation rules are stored locally.

21. A method as claimed in claim 2, wherein the reservation rules are stored as one or more arrays of data, each data value within the array indicating an item from the second range, the position of each data value indicating a corresponding item from the first range.

22. A method of creating a set of reservation availability records for a set of items, including:
obtaining availability information for each of said set of items; and encoding said availability information as data within an array, the position of the data within the array indicating the item to which that data relates.

23. A method as claimed in claim 22, wherein said items each include a plurality of subitems, the availability information including information relating to each of said subitems, and the data for each item indicating availability if there is availability for any of the subitems included within that item.

24. A method of receiving and displaying reservation availability information for a set of items within a range, including receiving a data array including availability data for each of said items, and
displaying the availability data for each of said items, associated with a value within said range derived from the position of the availability data within said array.

25. A set of reservation availability records created by the method of claim 22.

26. A set of reservation availability records created by the method of claim 23.

27. A computer program arranged to perform a method according to claim 1, when executed at said terminal.

28. A computer program arranged to perform a method according to any one of claim 15, when executed by a suitably arranged computer.

29. A signal encoding a computer program as claimed in claim 28.

30. An electronic travel reservation system comprising a server accessible over a network by a terminal, wherein the terminal sends a request specifying a plurality of dates and a specified route to the server and the server responds with the fare and availability records for the specified dates and route, the terminal then displaying one or more options to select from the requested fare and availability records and displaying a subset of said records according to a user selection of said one or more options.

31. A system as claimed in claim 30, wherein said displayed options include one or more options to select a specific fare type, and the subset of said records comprises records having a user-selected fare type.

32. A system as claimed in claim 30, wherein said displayed options include an option to select a lowest fare and the subset of said records comprises records corresponding to the lowest fare for each of said plurality of dates.

33. A system as claimed in claim 30, wherein said subset of said records is displayed by displaying some or all of said specified dates, each with an indicium selected from a set of indicia indicating the availability of a fare type for the respective day.
